(19) United States
(12) Patent Application Publication
(10) Pub. No.: US 2026/0127475 A1
(43) Pub. Date: May 7, 2026

(54) QUBIT RESET

(71) Applicant: IQM FINLAND OY, Espoo (FI)

(72) Inventors: Vasili SEVRIUK, Espoo (FI); Jami RÖNKKÖ, Espoo (FI); Fabian MARXER, Espoo (FI); Antti VEPSÄLÄINEN, Espoo (FI)

(21) Appl. No.: 19/117,510

(22) PCT Filed: May 22, 2023
(86) PCT No.: PCT/FI2023/050285

§ 371 Date: Apr. 1, 2025

(30) Foreign Application Priority Data
Oct. 3, 2022 (WO) PCT/FI2022/050657

(51) Int. Cl. G06N 10/40

(52) U.S. Cl. CPC G06N 10/40

(57) ABSTRACT

Various example embodiments relate to an arrangement for resetting at least one qubit. According to an embodiment, the arrangement comprises the at least one qubit, a dissipative environment, and a control unit configured to reset the at least one qubit by performing operations comprising applying a reset signal to the qubit. The reset signal is generated by amplitude modulation. The reset signal induces at least one sideband mode of the qubit. The sideband mode of the qubit overlaps with a frequency of the dissipative environment.

### TECHNICAL FIELD

The present disclosure relates to quantum computing, and more particularly to an arrangement for resetting at least one qubit, to a method for resetting at least one qubit, and to a quantum computing system.

### BACKGROUND

The ability to reset rapidly qubits with high fidelity is one of the prerequisites for coherent quantum computations.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to a first aspect, an arrangement for resetting at least one qubit comprises the at least one qubit, a dissipative environment configured to dissipate energy transferred from the at least one qubit, and a control unit. The control unit is configured to reset the at least one qubit by applying an amplitude modulated reset signal to the qubit. The amplitude modulated reset signal induces at least one sideband mode of the qubit. The sideband mode of the qubit overlaps with a frequency of the dissipative environment.

Some embodiments enable reset of one or more qubits, in particular tunable superconducting qubits. By applying an amplitude modulated reset signal to the qubit, a swap between the qubit and the dissipative environment is realized. As a result, the excited state population in the qubit is substantially reduced or suppressed.

Some embodiments provide an unconditional reset scheme for one or more qubits. By modulating the amplitude of the reset signal of the qubit, a controllable interaction is generated between the qubit and the dissipative environment. This interaction unconditionally transfers the qubit excitation to the dissipative environment. This allows on demand reset of the qubit.

Some embodiments enable fast reset with high fidelity. In some embodiments, with typical values of the sample, the reset can be achieved in less than 100 ns, with a fidelity of at least 99% or higher. In some embodiment, the reset can be achieved in less than 20 ns, with a fidelity of at least 99% or higher.

Some embodiments do not require a flux line. The absence of a flux line simplifies the wiring of the quantum architecture. A flux line is a source of noise which might affect the qubit. Therefore, the absence of a flux line may reduce or suppress effects of noise on the qubit. Further, a flux line might affect neighbouring qubits via crosstalk. Therefore, the absence of a flux line may reduce or suppress effects on neighbouring qubits.

Some embodiments only involve applying an amplitude modulated reset signal and do not need sophisticated calibration.

Some embodiments are compatible with circuit quantum electrodynamics (circuit QED) systems and can be applied to any type of qubit which can be combined with circuit QED, including frequency-tunable superconducting qubits as well as non-tunable qubits. Some embodiments do not require any additional hardware or modifications to chip components.

According to an example embodiment of the first aspect, the amplitude modulated reset signal is generated by modulating an amplitude of a carrier signal, wherein the carrier signal is off-resonant with the qubit.

According to an example embodiment of the first aspect, the off-resonant carrier signal induces a shift in the frequency of the qubit by the AC Stark effect. The off-resonant carrier signal is amplitude modulated such that the amplitude of the AC Stark shift is modulated. Thus, the amplitude modulated reset signal modulates the frequency of the qubit. The modulation of the qubit frequency creates a sideband in the frequency of the qubit. The frequency of the modulation is selected such that the sideband in the frequency of the qubit overlaps with the frequency of the dissipative environment.

According to an example embodiment of the first aspect, a frequency of the sideband mode of the qubit approximatively coincides with the frequency of the dissipative environment.

According to an example embodiment of the first aspect, a difference between the frequency of the sideband mode of the qubit and the frequency of the dissipative environment is less than a decay rate of the dissipative environment.

According to an example embodiment of the first aspect, a difference between the frequency of the sideband mode of the qubit and the frequency of the dissipative environment is less than 10% of the frequency of the dissipative environment, or less than 20% of the frequency of the dissipative environment.

According to an example embodiment of the first aspect, a difference between a frequency of the carrier signal and an initial frequency of the qubit is in a range of 50 to 500 MHz.

According to an example embodiment of the first aspect, the amplitude modulated reset signal is generated by modulating the amplitude of the carrier signal according to a modulating signal, wherein a frequency of the modulating signal approximately coincides with a frequency difference between a frequency of a central mode of the qubit and a frequency of the dissipative environment.

According to an example embodiment of the first aspect, the dissipative environment is a resonator, wherein the frequency of the dissipative environment is the frequency of a mode of resonance of the resonator.

According to an example embodiment of the first aspect, the resonator is a readout resonator or an additional resonator.

According to an example embodiment of the first aspect, a decay rate (of the dissipative environment is in a range of 5 to 20 MHz.

According to an example embodiment of the first aspect, the dissipative environment is capacitively coupled to the at least one qubit.

According to an example embodiment of the first aspect, the arrangement further comprises a drive line, the at least one qubit being coupled to the drive line, and wherein applying the amplitude modulated reset signal to the qubit comprises applying a first amplitude modulated reset signal to the qubit via the drive line.

According to an example embodiment of the first aspect, applying the amplitude modulated reset signal to the qubit comprises applying a second amplitude modulated reset signal to the qubit through the dissipative environment.

According to an example embodiment of the first aspect, the arrangement further comprises a flux line, the at least one qubit being coupled to the flux line, and wherein the operations further comprise applying a third reset signal to the qubit through the flux line.

According to a second aspect, a quantum computing system comprises at least one arrangement according to the first aspect.

According to a third aspect, a method for resetting at least one qubit using a dissipative environment comprises applying an amplitude modulated reset signal to the qubit, wherein the amplitude modulated reset signal induces at least one sideband mode of the qubit, wherein the sideband mode of the qubit overlaps with a frequency of the dissipative environment.

According to a fourth aspect, applying the amplitude modulated reset signal comprises one or more of: applying a first amplitude modulated reset signal to the qubit via the drive line; or applying a second amplitude modulated reset signal to the qubit through the dissipative environment.

According to a fifth aspect, an arrangement for resetting at least one qubit comprises: the at least one qubit; a drive line, the at least one qubit being coupled to the drive line; a dissipative environment configured to dissipate energy transferred from the at least one qubit; and a control unit configured to reset the at least one qubit by performing operations comprising: applying a reset signal to the qubit through the drive line, wherein the reset signal is generated by amplitude modulation, wherein the reset signal induces at least one sideband mode of the qubit, wherein the sideband mode of the qubit overlaps with a frequency of the dissipative environment.

According to an embodiment of the fifth aspect, a frequency of the sideband mode of the qubit approximatively can coincide with the frequency of the dissipative environment.

According to an embodiment of the fifth aspect, a difference between the frequency of the sideband mode of the qubit and the frequency of the dissipative environment can be less than a decay rate of the dissipative environment.

According to an embodiment of the fifth aspect, a difference between the frequency of the sideband mode of the qubit and the frequency of the dissipative environment can be less than 10% of the frequency of the dissipative environment, or less than 20% of the frequency of the dissipative environment.

According to an embodiment of the fifth aspect, the reset signal can induce a shift of a frequency of a central mode of the qubit to a shifted value, wherein the signal is generated by modulating an amplitude of a carrier signal by a modulating signal, wherein a frequency of the modulating signal approximately coincides with a frequency difference between the shifted value of the frequency of the central mode of the qubit and a frequency of the dissipative environment.

According to an embodiment of the fifth aspect, a difference between a frequency of the carrier signal and an initial frequency of the qubit can be in a range of 50 to 500 MHz.

According to an embodiment of the fifth aspect, the dissipative environment can be a resonator, wherein the frequency of the dissipative environment is the frequency of a mode of resonance of the resonator.

According to an embodiment of the fifth aspect, the resonator can be a readout resonator r an additional resonator.

According to an embodiment of the fifth aspect, a decay rate of the dissipative environment can be in a range of 5 to 20 MHz.

According to an embodiment of the fifth aspect, the dissipative environment can be capacitively coupled to the at least one qubit.

According to an embodiment of the fifth aspect, the at least one qubit can comprise at least one superconducting qubit.

According to a sixth aspect, a quantum computing system can comprise at least one arrangement according to any embodiment of the fifth aspect.

According to a seventh aspect, a method for resetting at least one qubit using a dissipative environment, the at least one qubit being coupled to a drive line, the method comprises: applying a reset signal to the qubit through the drive line, wherein the reset signal is generated by amplitude modulation, wherein the reset signal induces at least one sideband mode of the qubit, wherein the sideband mode of the qubit overlaps with a frequency of the dissipative environment.

Many of the attendant features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1A illustrates a schematic representation of an arrangement for resetting at least one qubit according to a first example of the first aspect;

FIG. 1B illustrates a schematic representation of an arrangement for resetting at least one qubit according to a second example of the first aspect.

FIG. 1C illustrates a schematic representation of an arrangement for resetting at least one qubit according to a third example of the first aspect.

FIG. 1D illustrates a schematic representation of an arrangement for resetting at least one qubit according to a fourth example of the first aspect.

FIG. 1E illustrates a schematic representation of an arrangement for resetting at least one qubit according to a fifth example of the first aspect.

FIG. 2A illustrates a schematic circuit diagram of an arrangement for resetting at least one qubit according to a first example of the first aspect;

FIG. 2B illustrates a schematic circuit diagram of an arrangement for resetting at least one qubit according to a second example of the first aspect.

FIG. 3 illustrates a reset signal of a qubit as a function of time (f(t)) according to an embodiment;

FIG. 4 illustrates a modulating signal as a function of time (m(t)) according to an embodiment;

FIG. 5 illustrates an AC Stark shift in the qubit frequency according to an embodiment;

FIG. 6 illustrates a qubit system frequency spectrum in the presence of the reset signal according to an embodiment;

FIG. 7 illustrates a schematic representation of a control unit according to an embodiment; and

FIG. 8 illustrates a flow chart representation of a method for resetting at least one qubit according to an embodiment.

In the following, like reference numerals are used to designate like parts in the accompanying drawings.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

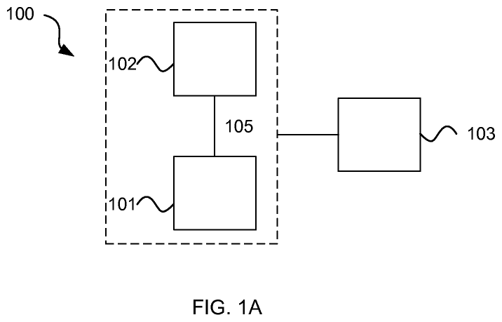

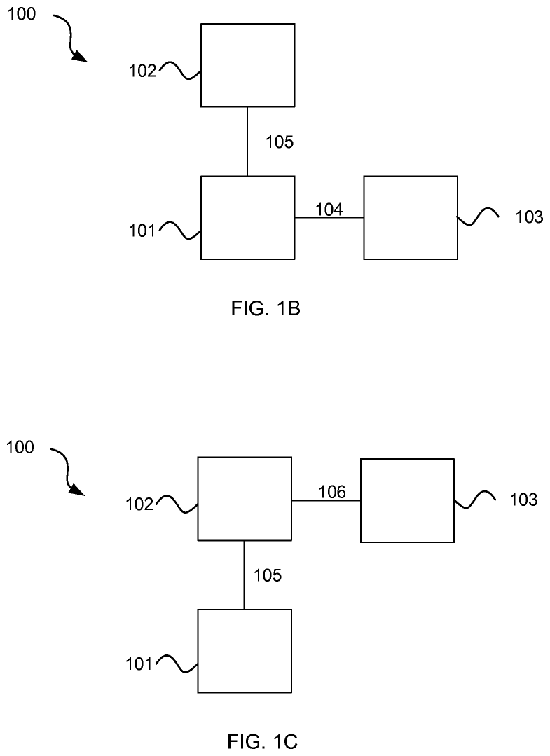

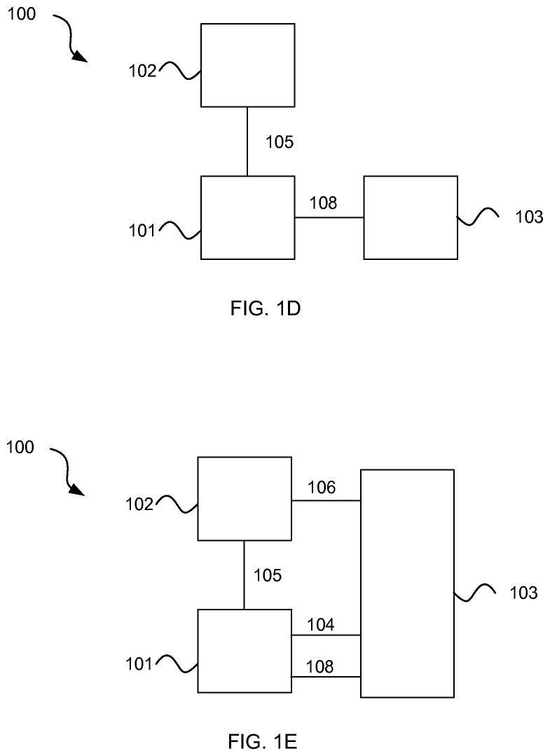

FIG. 1A illustrates a schematic representation of an arrangement 100 for resetting at least one qubit according to an embodiment.

According to an embodiment, the arrangement 100 comprises at least one qubit 101.

Herein qubit may refer to any two-level system that can be part of a multi-level system.

The at least one qubit 101 has a ground state |g [symbol] and at least one excited state. Herein, the ground state may refer to a quantum state of the qubit with the lowest energy. The at least one excited state may comprise a lowest excited state |e [symbol] . Herein, the lowest excited state may refer to a quantum state of the qubit with the second lowest energy.

In some embodiments, the ground state and the lowest excited state of a qubit may correspond to the computational basis of the qubit. For example, the ground state |g [symbol] may correspond to the |0 [symbol] state of the qubit and the lowest excited state |e [symbol] may correspond to the |1 [symbol] state of the qubit or vice versa. Other quantum states qubit may be referred to as non-computational states.

The energy gap between the ground state and the lowest excited state may correspond to a resonance frequency of the qubit. The energy gap may also be referred to as the qubit energy, and the corresponding frequency as the qubit frequency ω_{q}, or operational frequency of the qubit.

Herein, resetting a qubit may refer to the act of transitioning a qubit to a pure quantum state, typically the ground state, after, for example, a quantum computation. Resetting a qubit may also be referred to as initializing the qubit.

Resetting a qubit may refer to transitioning the qubit from any energy level to any lower energy level.

The arrangement 100 further comprises a dissipative environment 102 coupled or couplable to the qubit 101. The dissipative environment 102 is configured to dissipate energy transferred from the at least one qubit.

The dissipative environment 102 has at least one mode of resonance. The frequency of the dissipative environment may refer to the frequency of the at least one mode of resonance of the dissipative environment.

In particular, the frequency of the dissipative environment may refer to the frequency of the fundamental mode of the dissipative environment 102, or alternatively to other modes of resonance of the dissipative environment 102. The dissipative environment 102 may be a narrow band environment in the sense that the fundamental mode of resonance of the dissipative environment 102 occupies a narrow range of frequency.

The dissipative environment 102 may be a dissipative qubit, a linear or a nonlinear resonator, or any other set of dissipative energy levels.

The dissipative environment 102 may also be referred to as an energy dissipation structure, an energy relaxation structure, a controllable environment, a controllable energy dissipation structure, an engineered environment, a bath, a dissipation source, or similar.

The dissipative environment 102 has a dissipation rate or decay rate kr. Kr can be selected to be high enough such that energy transferred from the qubit to the dissipative environment during reset can be quickly dissipated, but not too high to limit the effect of the dissipative environment on the qubit. In some embodiments, κr may be in the range of 10-20 MHz.

The dissipative environment 102 may be a resonator. Although some embodiments and analysis disclosed herein may refer to specific implementations of the dissipative environment as a resonator, it should be appreciated that the dissipative environment may be implemented using any other type of dissipative environment.

The resonator 102 may be a readout resonator used both for read-out and reset of the qubit, or an additional resonator used for resetting the qubit only.

The resonator 102 is configured to dissipate energy transferred from the qubit 101. The resonator 102 may be a damping resonator, which may also be referred to as a lossy resonator, a decaying resonator, a dispersive resonator, or a highly damped resonator. The damping may result from the resonator being lossy, which leads to the decay of its excitation number.

Alternatively, or additionally, the interaction between the resonator 102 and the qubit 101 may be dispersive.

A typical dissipation rate of a readout resonator may be around 10 MHz.

The resonator 102 has at least one mode of resonance. The frequency ωᵣ of the resonator 102 may refer to the frequency of the at least one mode of resonance of the resonator, and in particular to the fundamental mode of the resonator, or alternatively other modes of the resonator. In some embodiments, the frequency ωᵣ of the resonator 102 may be in the range of 3-10 GHz.

Although some embodiments and analysis disclosed herein may refer to specific implementations of the resonator 102, it should be appreciated that the resonator 102 may be implemented using, for example, any resonator with a coupling to the at least one qubit 101.

The dissipative environment 102 is coupled to the qubit 101. In particular, the dissipative environment 102 may be capacitively coupled to the qubit 101. The dissipative environment 102 may be connected to the qubit 101 via a capacitive connection 105. The capacitive connection may comprise any number of electrical components/elements, such as capacitors, inductors, transmission lines etc. In particular, the capacitive coupling may be achieved by placing a capacitor between two elements.

The qubit 101 and the dissipative environment 102 may be capacitively coupled continuously or selectively. The strength of interaction between the dissipative environment 102 and the qubit 101 may be controlled and/or turned on or off. It should be appreciated that even if there is a continuous capacitive connection between the dissipative environment 102 and the qubit 101, the interaction can be tuned.

For example, in some embodiments, the coupling strength may be in the range of 100-500 MHz. The coupling strength can be tuned if other parameters are changed. The qubit T1 (energy relaxation rate, e.g., thermal relaxation time) is not limited by the coupling to the dissipative environment 102.

Additionally, or alternatively, the properties of the dissipative environment 102 may be controllable.

The arrangement 100 further comprises a control unit 103 configured to reset the at least one qubit 101. The control unit 103 is configured to reset the qubit by applying an amplitude modulated reset signal to the qubit 101. The amplitude modulated reset signal modulates the frequency of the qubit, thereby resetting the qubit 101.

The reset signal is amplitude modulated. In other word, the reset signal is generated by amplitude modulation of a carrier signal.

The carrier signal may be off-resonant with the qubit. In other words, a frequency of the carrier signal is close but not equal to the frequency of the qubit. The off-resonant carrier signal induces a shift in the frequency of the qubit by the AC Stark effect (also called Autler-Townes effect). This shift is called AC Stark shift.

The carrier signal is amplitude modulated according to a modulating signal (or modulation signal). In other words, the amplitude (or signal strength) of the carrier signal is varied in proportion to that of the modulating signal. As such, the amplitude of the AC Stark shift is modulated according to the modulating signal. The amplitude modulated reset signal thus modulates the frequency of the qubit.

In the frequency domain, the modulation of the qubit frequency creates at least one sideband (e.g., two sidebands).

The frequency of the modulation is selected such that the sideband in the frequency of the qubit overlaps with the frequency of the dissipative environment 102.

When the sideband in the frequency of the qubit overlaps with the frequency the of dissipative environment 102, a coupling between the qubit 101 and the dissipative environment 102 is increased. The coupling may also be referred to as effective coupling.

The coupling induces Rabi oscillations between the excited state of the qubit and the dissipative environment state (e.g., |e, 0 [symbol] and |g, 1 [symbol] , where |s, 1 [symbol] is the tensor product of the qubit state |s [symbol] , and the dissipative environment state |1 [symbol] ). This creates a swap between the qubit state and the dissipative environment state. When the qubit is excited, the population is transferred from the qubit state (e.g., |e, 0 [symbol] ) to the dissipative environment state (e.g., |g, 1 [symbol] ). The population then rapidly decays in the dissipative environment 102 to the target state (e.g., |g, 0 [symbol] ) at decay rate kr.

The frequency of the modulation is selected to match the energy difference between the excited state of the qubit and the dissipative environment state. For example, to reset the first excited state e of the qubit, the frequency of the modulating signal is selected to match the energy difference between |e0> and |g1> states.

To reset a higher excited state of the qubit, the frequency of the modulation is selected to match the energy difference between the higher excited qubit state and the dissipative environment state. For example, to reset the second excited state f, the frequency of the modulation is selected to match the energy difference between |f0> and |g1>, thus resetting the second excited state f of the qubit.

A duration of the reset signal may be in the range of 20 to 100 ns. The reset signal may be applied before any quantum computations on the qubit and/or after the quantum computations.

As illustrated by FIG. 1B, the arrangement 100 may comprise a drive line 104 (e.g., xy driveline). A drive signal can be applied to the qubit 101 through the drive line 104. The control unit 103 may be configured to apply the amplitude modulated reset signal to the qubit 101 via the drive line 104 (e.g., XY drive line 104).

As illustrated by FIG. 1C, the control unit 103 may be configured to apply the amplitude modulated reset signal to the qubit 101 through the dissipative environment 102. The amplitude modulated reset signal may be applied to the dissipative environment 102 via a transmission line 106 (e.g., transmission line of the readout structure, or a separate transmission line).

As illustrated by FIG. 1D, the arrangement 100 may comprise a flux line 108 (e.g., Z flux line). A flux bias signal can be applied to the qubit 101 through the flux line 108. The control unit 103 may be further configured to reset the qubit 101 by modulating the flux (e.g., by applying a modulating signal via the flux line 108). Modulating the flux directly modulates the frequency of the qubit, thereby resetting the qubit 101.

As illustrated by FIG. 1E, in some embodiments, different qubit frequency modulation techniques may be combined, including: applying an amplitude modulated reset signal via the drive line, applying an amplitude modulated reset signal via the dissipative environment 102, and/or by applying a modulating signal via the flux line. In particular, the control unit 103 may be configured to apply a first amplitude modulated reset signal via the drive line, and a second amplitude modulated reset signal via the dissipative environment 102.

The qubit frequency can be coherently modulated by different modulating signals (e.g., according to different qubit frequency modulation techniques). The different modulating signals produce a combined time dependence of the qubit frequency. In some cases, e.g., due to the limitations in the real setup, a single modulating signal cannot produce a high enough frequency or amplitude in the modulation of the qubit frequency. The parameters of the different modulating signals may be chosen such that a higher amplitude of the modulation or a higher frequency of the modulation can be obtained. The frequency of the modulation is the combination of the frequencies of the applied modulating signals.

The different qubit frequency modulation techniques can also be combined with other microwave drive-based reset methods (e.g., reset method described in Magnard, Paul, et al. “Fast and unconditional all-microwave reset of a superconducting qubit.” Physical review letters 121.6 (2018): 060502).

In particular, the carrier signal may be configured to realize a microwave drive-based reset of a first state (e.g., f-state), while the amplitude modulation of the carrier signal simultaneously causes an AC Stark reset of a second state (e.g., e-state). For example, the carrier signal may be configured to realize a f-state reset, e.g., via f0g1 reset (e.g., with a microwave drive in resonance with the difference between qubit f0 state and resonator g1 state), while the amplitude modulation of the carrier signal simultaneously causes a e-state AC Stark reset.

According to some embodiments, the at least one qubit 101 comprises at least one superconducting qubit. According to some embodiments, the at least one qubit 101 comprises at least one Josephson junction. According to some embodiments, the at least one qubit 101 comprises a transmon qubit. Alternatively, the at least one qubit 101 may comprise any other type of qubit, such as, a flux qubit, a charge qubit, a phase qubit, or a fluxonium qubit.

Although some embodiments may be disclosed herein with reference to a certain type of qubit, these qubit types are only exemplarily. In any embodiment disclosed herein, the at least one qubit 101 may be implemented in various ways and using various technologies. In particular, the qubit may be any type of qubit which can be combined with circuit QED, including frequency-tunable qubits as well as non-tunable qubits. More generally, the reset scheme can be used for any qubit that can be coupled to a dissipative environment 102.

The arrangement 100 may be embodied in, for example, a quantum computing system. Such a quantum computing system may comprise a plurality of qubits for performing quantum computation. The quantum computing system may comprise at least one arrangement 100 for resetting at least one of the qubits.

The arrangement 100 may be realized, for example, in a superconducting circuit architecture.

When the arrangement 100 is operational, the at least one qubit 101 and the dissipative environment 102 may be physically located in a cryostat or similar. The cryostat may cool the at least one qubit 101 and other components of the arrangement 100, such as the dissipative environment 102, to cryogenic temperatures. This may be required if the at least one qubit 101 correspond to, for example, a superconducting qubit.

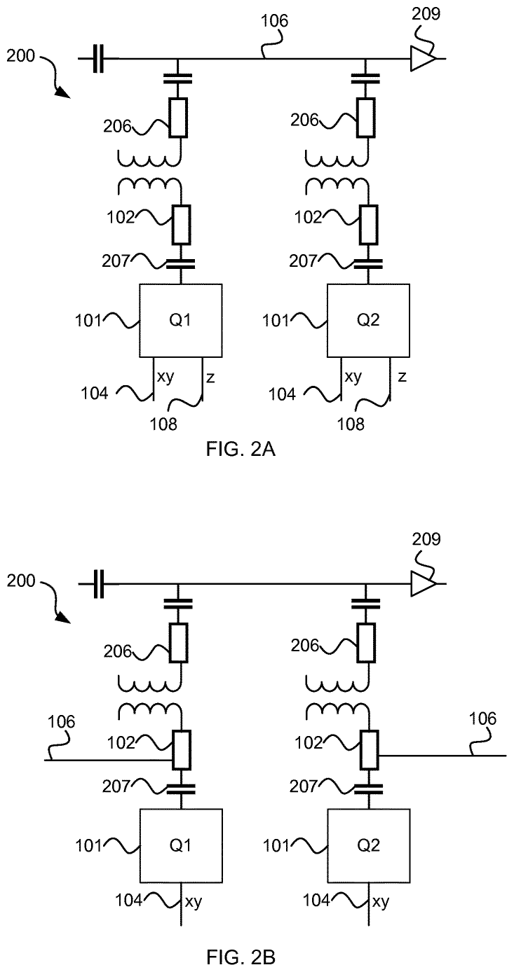

FIGS. 2A and 2B illustrates a schematic circuit diagram of an arrangement for resetting at least one qubit according to example embodiments. FIGS. 2A and 2B illustrates an arrangement comprising two qubits 101, but it is understood that the arrangement may comprise any number of qubits 101.

Each qubit 101 may be capacitively coupled to a resonator (e.g., readout resonator) via a capacitor 207.

Each resonator 102 may be inductively or capacitively coupled to a respective Purcell filter. The Purcell can limit or mitigate unwanted decay of the qubit 101 due to the coupled resonator 102. The Purcell filter may be implemented by a λ/4 resonator 206.

As illustrated in FIG. 2A, each resonator 102 may be coupled to a readout transmission line 106 of a readout structure. Multiple readout resonators 102 may be coupled to a single readout transmission line 106. Each readout resonator 102 may have different properties (e.g., resonance frequency). Due to the different properties of the readout resonators 102, different carrier frequencies affect different qubits. The carrier frequency of the signal applied to the transmission line 106 can thus be selected to selectively modulate the frequency of one qubit. As such, the frequency of each qubit can be individually modulated.

As illustrated in FIG. 2B, each resonator 102 may also be individually coupled to a respective transmission line 106. As such, the frequency of each qubit can be individually modulated, e.g., even if the readout resonators 102 are not sufficiently different from each other, or if the reset signal has a high amplitude that could affect more than one qubit.

The readout signal may be amplified by an impedance-matched Josephson parametric amplifier 209.

Each qubit 101 may be coupled to a respective XY drive line 104.

Each qubit 101 may be coupled to a respective Z flux line 108.

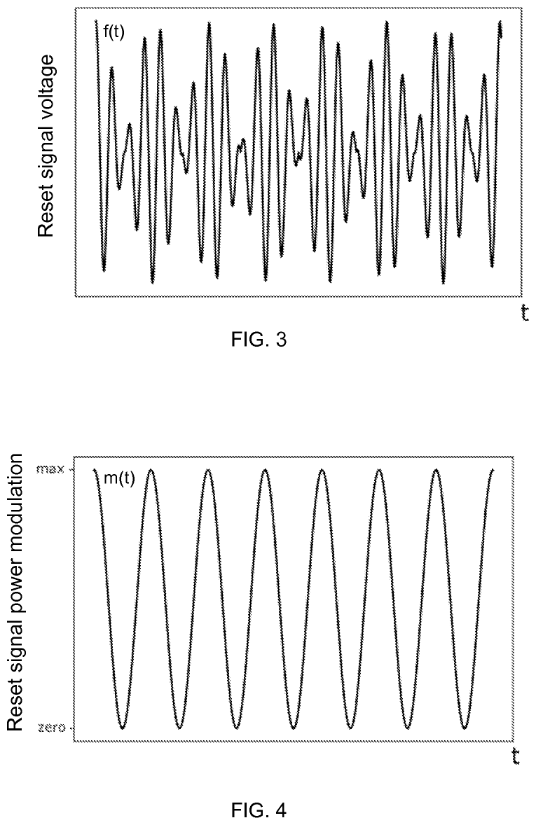

FIG. 3 illustrates a reset signal as a function of time (f(t)) according to an embodiment. As illustrated by FIG. 3, the reset signal corresponds to a carrier signal whose amplitude is modulated by a modulating signal.

FIG. 4 illustrates the modulating signal as a function of time (m(t)) according to an embodiment. As illustrated by FIG. 4, the modulating signal m(t) may be a single sine or cosine wave. The modulating signal modifies the amplitude of the carrier signal and determines the envelope of the waveform.

The voltage of the reset signal can be expressed as follows:

$$V ( t ) = {V}_{0} cos ( {ω}_{c} t ) \sqrt{( 1 + cos ( {ω}_{Δ} T ) ) / 2}$$

ω_{c}—being the frequency of the carrier signal,
ω_{Δ}—being the frequency of the modulating signal.

The carrier signal may be off-resonant with the qubit 101. In other words, a frequency ω_{c} of the carrier signal is close but not equal to the frequency of the qubit 101 (e.g., the initial frequency ω₀ of the qubit). The frequency ω_{c} of the carrier signal should be close enough to the frequency ω_{q} of the qubit 101 such that the AC Stark shift is high enough, but not too close to limit unwanted qubit excitation.

The detuning of the carrier signal is the difference between the frequency ω_{c} of the carrier signal and the frequency ω_{g} of the qubit 101.

As an example, in some embodiments, the detuning of the carrier signal may be in a range of 50 to 500 MHz, and in particular in the range of 100 to 300 MHz. Such detuning creates a sufficiently large AC Stark effect, while limiting unwanted qubit excitation.

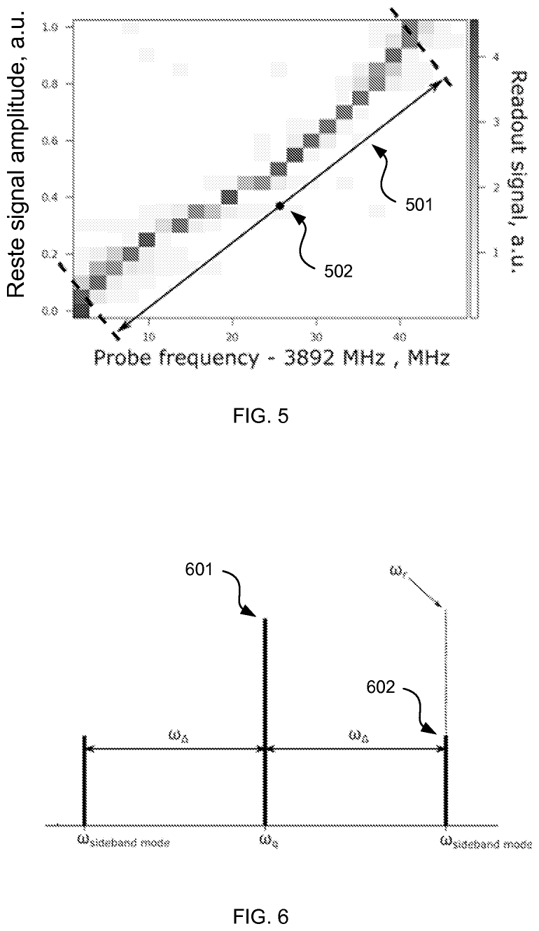

FIG. 5 illustrates the AC Stark shift in the qubit frequency. FIG. 5 illustrates the experimental results of a qubit spectroscopy. FIG. 5 shows the measured readout signal as a function of the modulation amplitude, and of a probe frequency. The contrast in the readout signal indicates the frequency of the probe signal at which the qubit state is affected by the probe. In other words, the contrast in the readout signal corresponds to the qubit frequency.

FIG. 5 shows that the AC Stark shift in the qubit frequency can be modulated around a central frequency 502 of an AC Stark shift range 501 by modulating the amplitude of the carrier signal. In the illustrated example, the AC Stark shift range is approximately 40 MHz.

The modulating signal may be a sine or cosine function around the central frequency 502 of the AC Stark shift range 501. The range 501 of the AC Stark shift modulation determines the strength and thus the time of the reset.

The qubit frequency ω_{q} can be expressed as

$${ω}_{0} + \frac{ϑ}{2}$$

where ω₀ is the initial frequency of the qubit without any reset signal, and ϑ is the maximum AC Stark shift.

The AC Stark shift in the frequency of the qubit can be expressed as

$$ϑ = a * {P}_{i n}$$

Pᵢₙ is the input power.
a is a coefficient that depends on the detuning of the carrier signal, as well as the coupling strength between the drive line and the qubit and/or between the dissipative environment and the qubit. The value of coefficient a as well as the value of the AC Stark shift is a compromise between creating a sufficient AC Stark shift and limiting unwanted qubit excitation.

FIG. 6 illustrates a frequency spectrum of the qubit system in the presence of the reset signal according to an embodiment.

The reset signal induces a shift in a frequency ω_{q} of a central mode 601 of the qubit. During reset, the frequency ω_{q} of the central mode 601 of the qubit is shifted from an initial value to a shifted value.

In addition, the reset signal induces at least one sideband mode 602 of the qubit. During reset, the difference between the frequency ω_{q} of the central mode 601 of the qubit and the frequency ωₛ of the sideband mode 602 of the qubit is equal to the frequency ω_{Δ} of the modulating signal.

During reset, the sideband 602 mode of the qubit should overlap with the frequency ωᵣ of the dissipative environment 102 coupled to the qubit 101. To that end, the frequency ω_{Δ} of the modulating signal is selected such that the sideband 602 overlaps with the frequency ωᵣ of the dissipative environment 102.

In some embodiments, the frequency ωₛ of the sideband mode approximatively coincides with the frequency ωᵣ of the dissipative environment 102.

The acceptable difference between the frequency ωₛ of the sideband mode 602 and the frequency ωᵣ of the dissipative environment 102 may be defined by the detuning of the dissipative environment 102. The detuning of the dissipative environment 102 is the difference between the frequency ωᵣ of the dissipative environment 102 and the frequency ω_{q} of the qubit 101. The closer the frequency ωₛ of the sideband with the frequency ωᵣ of the dissipative environment 102, the faster the reset. In the meantime, the frequency ωᵣ of the dissipative environment 102 should not be too close to the frequency ω_{q} of the qubit 101 to limit the effect of the dissipative environment 102 on the qubit 101.

For example, in some embodiments, the detuning of the dissipative environment 102 may for example be in the range of 0.5 to 1.5 GHz.

Effective reset typically requires that a difference between the frequency ωₛ of the sideband mode 602 and the frequency ωᵣ of the dissipative environment 102 should be less than the decay rate κr of the dissipative environment 102. However, some effect can be seen if the frequency ωₛ of the sideband mode 602 and the frequency ωᵣ of the dissipative environment 102 are close to each other, e.g., the difference is less than 10 percent of the frequency ωᵣ of the dissipative environment 102, or less than 20 percent of the frequency ωᵣ of the dissipative environment 102. For example, for a decay rate κr around 10 MHz, the acceptable difference between the frequency ωₛ of the sideband mode 602 and the frequency ωᵣ of the dissipative environment 102 may be less than 100 MHz, less than 0.5 GHz, or less than 1 GHz.

In some embodiments, the frequency ω_{Δ} of the modulating signal approximately coincides a with difference between the shifted value of the frequency ω_{q} of the central mode 601 of the qubit 101 and the frequency ωᵣ of the dissipative environment 102. Since the difference between the shifted value of the frequency ω_{q} of the central mode of the qubit and the frequency ωₛ of the sideband mode of the qubit is equal to the frequency ω_{Δ} of the modulating signal, the frequency ωₛ of the sideband approximately coincides with the frequency ωᵣ of the dissipative environment 102.

As an example, in some embodiments, the detuning of the dissipative environment 102 may be in the range of 0.5 to 1.5 GHz. The frequency of the modulating signal may therefore be in a range of 0.5 to 1.5 GHz.

The Hamiltonian describing the system including the qubit 101 and the dissipative environment 102 is:

$$H = \frac{{ω}_{q} {σ}_{z}}{2} + {ω}_{r} {α}^{†} α + {g}_{0} ( {σ}_{+} {α}^{†} + {σ}_{-} α )$$

ω_{q}—qubit frequency,
ωᵣ—resonator frequency,
g₀—qubit-resonator coupling strength.

The modulated qubit frequency is:

$${ω}_{q} = {ω}_{0} + \frac{ϑ}{2} ( 1 + cos ( {ω}_{Δ} T ) )$$

ω_{Δ}—qubit-resonator frequency difference,
ω₀—initial frequency of the qubit without any reset signal,
ϑ—AC Stark shift.

The interacting Hamiltonian is:

$${H}_{int} = {g}_{0} exp ( i \frac{ϑ}{2 {ω}_{Δ}} sin ( {ω}_{Δ} T ) ) ( exp ( i {ω}_{Δ} T ) \vert e 0 〉 〈 g 1 \vert + h . c . )$$

When putting exp into series and taking only first two terms, the interacting Hamiltonian can be expressed as:

$${H}_{int} = [ {g}_{0} {J}_{0} ( \frac{ϑ}{2 {ω}_{Δ}} ) + {g}_{0} {J}_{1} ( \frac{ϑ}{2 {ω}_{Δ}} ) ( exp ( i {ω}_{Δ} T ) - exp ( - i {ω}_{Δ} T ) ) ] ( exp ( i {ω}_{Δ} T ) \vert e 0 〉 〈 g 1 \vert + h . c . )$$

The effective coupling between the qubit and resonator is:

$${g}_{e f f} = {g}_{0} {J}_{1} ( \frac{ϑ}{2 {ω}_{Δ}} )$$

J₀—Bessel function.

The effective Hamiltonian of the excitation evolution within the system is:

$${H}_{eff} = ( \begin{matrix}0 & {g}_{eff} \\ {g}_{eff} & - i \frac{{κ}_{r}}{2}\end{matrix} )$$

κr—resonator dissipation rate.
   As such, the system goes to the ground state at the rate of

$$\frac{{κ}_{r}}{2} .$$

The residual population of the qubit is also defined by the thermal noise and decay constant of the resonator.

In some embodiments, the reset of the qubit can be done faster in case of the underdamped regime. The qubit population would then oscillate with the frequency:

$$\sqrt{4 {g}_{e f f}^{2} - \frac{{κ}_{r}^{2}}{4}}$$

For a typical dissipation rate of the dissipative environment 102 of 10 MHz,

$$\frac{2}{{κ}_{r}}$$

is around 200 ns. If the T1 of the qubit is 50 μs, then the residual thermal population of the qubit after the reset should be 250 time better than the bare qubit population. For a typical value for g₀ of 200 MHz, and a detuning between the qubit and resonator of 0.5 GHz, the reset of the qubit can be done in 80 ns.

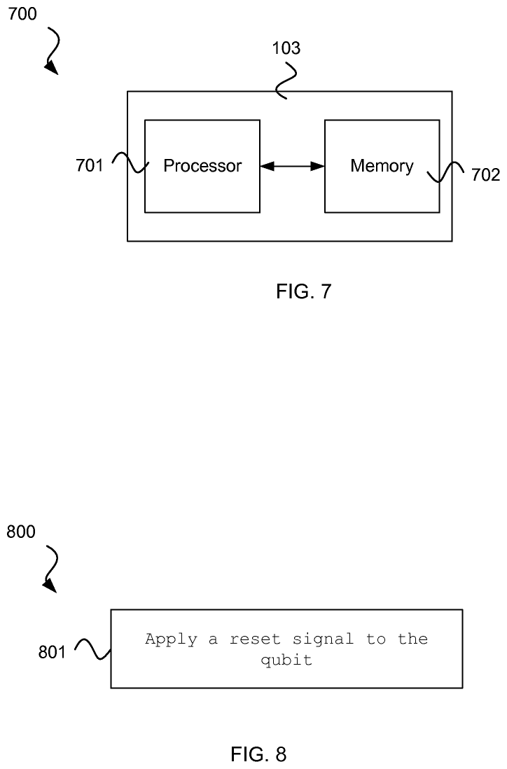

FIG. 7 illustrates a schematic representation of a control unit 103 according to an embodiment.

The control unit 103 may be configured to generate and/or control the reset signal provided to the qubit 101.

The control unit 103 may comprise at least one processor 701. The at least one processor 701 may comprise, for example, one or more of various processing devices, such as a co-processor, a microprocessor, a digital signal processor (DSP), a processing circuitry with or without an accompanying DSP, or various other processing devices including integrated circuits such as, for example, an application specific integrated circuit (ASIC), a field programmable gate array (FPGA), a microprocessor unit (MCU), a hardware accelerator, a special-purpose computer chip, or the like.

The control unit 103 may further comprise a memory 702. The memory 702 may be configured to store, for example, computer programs and the like. The memory 702 may comprise one or more volatile memory devices, one or more non-volatile memory devices, and/or a combination of one or more volatile memory devices and non-volatile memory devices. For example, the memory 702 may be embodied as magnetic storage devices (such as hard disk drives, floppy disks, magnetic tapes, etc.), optical magnetic storage devices, and semiconductor memories (such as mask ROM, PROM (programmable ROM), EPROM (erasable PROM), flash ROM, RAM (random access memory), etc.).

The control unit 103 may further comprise other components not illustrated in the embodiment of FIG. 7. The control unit 103 may comprise, for example, an input/output bus for connecting the control unit 103 to other devices. Further, a user may control the control unit 103 via the input/output bus. The user may, for example, control quantum computation operations performed by the arrangement 100 via the control unit 103 and the input/output bus.

The control unit 103 may further comprise an appropriate signal source for generating and controlling the reset signal. For example, the control unit 103 may comprise at least one arbitrary waveform generator (AWG) and at least one microwave source. The AWG may be further used to control and readout the qubit.

When the control unit 103 is configured to implement some functionality, some component and/or components of the control unit 103, such as the at least one processor 701 and/or the memory 702, may be configured to implement this functionality.

Furthermore, when the at least one processor 701 is configured to implement some functionality, this functionality may be implemented using program code comprised, for example, in the memory.

The control unit 103 may be implemented using, for example, a computer, some other computing device, or similar.

FIG. 8 illustrates a flow chart representation of a method 800 for resetting at least one qubit according to an embodiment.

At operation 801, the method comprises applying a reset signal to the qubit 101, wherein the reset signal is generated by amplitude modulation, wherein the reset signal induces at least one sideband mode 602 of the qubit 101, wherein the sideband mode 602 of the qubit 101 overlaps with a frequency of the dissipative environment 102.

The method 800 may be performed by, for example, the control unit 103.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An arrangement for resetting at least one qubit, comprising:
the at least one qubit;
a dissipative environment configured to dissipate energy transferred from the at least one qubit; and
a control unit configured to reset the at least one qubit by performing operations comprising:
applying an amplitude modulated reset signal to the qubit, wherein the amplitude modulated reset signal induces at least one sideband mode of the qubit, wherein the sideband mode of the qubit overlaps with a frequency of the dissipative environment.

2. The arrangement according to claim 1, wherein a frequency of the sideband mode of the qubit approximatively coincides with the frequency of the dissipative environment.

3. The arrangement according to claim 2, wherein a difference between the frequency of the sideband mode of the qubit and the frequency of the dissipative environment is less than a decay rate of the dissipative environment.

4. The arrangement according to claim 2, wherein a difference between the frequency of the sideband mode of the qubit and the frequency of the dissipative environment is less than 10% of the frequency of the dissipative environment, or less than 20% of the frequency of the dissipative environment.

5. The arrangement according to claim 1 claim, wherein the amplitude modulated reset signal is generated by modulating an amplitude of a carrier signal, wherein the carrier signal is off-resonant with the qubit.

6. The arrangement according to claim 5, wherein a difference between a frequency of the carrier signal and an initial frequency of the qubit is in a range of 50 to 500 MHz.

7. The arrangement according to claim 5, wherein the amplitude modulated reset signal is generated by modulating the amplitude of the carrier signal according to a modulating signal, wherein a frequency of the modulating signal approximately coincides with a frequency difference between a frequency of a central mode of the qubit and a frequency of the dissipative environment.

8. The arrangement according to claim 1, wherein the dissipative environment is a resonator, wherein the frequency of the dissipative environment is the frequency of a mode of resonance of the resonator.

9. The arrangement according to claim 8, wherein the resonator is a readout resonator or an additional resonator.

10. The arrangement according to claim 1, wherein a decay rate of the dissipative environment is in a range of 5 to 20 MHz.

11. The arrangement according to claim 1, wherein the dissipative environment is capacitively coupled to the at least one qubit.

12. The arrangement according to claim 1, wherein the arrangement further comprises a drive line, the at least one qubit being coupled to the drive line, and wherein applying the amplitude modulated reset signal to the qubit comprises applying a first amplitude modulated reset signal to the qubit via the drive line.

13. The arrangement according to claim 1, wherein applying the amplitude modulated reset signal to the qubit comprises applying a second amplitude modulated reset signal to the qubit through the dissipative environment.

14. The arrangement according to claim 1, wherein the arrangement further comprises a flux line, the at least one qubit being coupled to the flux line, and wherein the operations further comprise applying a third reset signal to the qubit through the flux line.

15. A quantum computing system comprising at least one arrangement according to claim 1.

16. A method for resetting at least one qubit using a dissipative environment, the method comprising:
applying an amplitude modulated reset signal to the qubit, wherein the amplitude modulated reset signal induces at least one sideband mode of the qubit, wherein the sideband mode of the qubit overlaps with a frequency of the dissipative environment.

17. A method according to claim 16, wherein applying the amplitude modulated reset signal comprises one or more of:
applying a first amplitude modulated reset signal to the qubit-via a drive line; or
applying a second amplitude modulated reset signal to the qubit through the dissipative environment.
